(19) United States
(12) Patent Application Publication
(10) Pub. No.: US 2025/0386288 A1
(43) Pub. Date: Dec. 18, 2025

(54) Carrier Selection Device and Method for Selecting a Wireless Carrier In Wireless Networks

(71) Applicant: AMETEK, INC., Berwyn, PA (US)

(72) Inventors: Gary Russo, Selden, NY (US); Sean Stewart, Atlanta, GA (US); Daniel Rosales, Kennesaw, GA (US)

(73) Assignee: AMETEK, INC., Berwyn, PA (US)

(21) Appl. No.: 19/240,879

(22) Filed: Jun. 17, 2025

Related U.S. Application Data
(60) Provisional application No. 63/660,814, filed on Jun. 17, 2024.

(51) Int. Cl. H04W 48/18; H04W 24/08

(52) U.S. Cl. CPC H04W 48/18; H04W 24/08

(57) ABSTRACT

Provided are systems, methods, and computer program products including a processor, a transceiver coupled to the processor, and memory coupled to the processor. The memory stores program instructions that will cause the processor to be configured to establish cellular service with each of one or more cellular carriers; receive plural signals transmitted via control channels for each cellular carrier; measure the plural signals to determine a signal strength of each of the plural signals; evaluate the signal strength of each of the plural signals by ranking the signal strength of each of the plural signals from a strongest signal to a weakest signal; select a first cellular carrier of the one or more cellular carriers based on ranking the signal strength of each of the plural signals, wherein the first cellular carrier transmitted the strongest signal; and maintain cellular service with the first cellular carrier.

### CROSS-REFERENCE

This U.S. non-provisional patent application is related to and claims priority to U.S. Provisional Application No. 63/660,814, filed on Jun. 17, 2024, the entire contents of which are incorporated herein by reference.

The subject matter disclosed relates generally to the field of telecommunications, and, in some embodiments, to devices and methods for selecting a wireless carrier in wireless network systems. Some embodiments can include methods, systems, and non-transitory computer readable media relating to signal reception and selecting a wireless carrier based on establishing service with the wireless carrier.

### BACKGROUND INFORMATION

In some instances, wireless devices (e.g., cellular devices) may be configured to communicate within a network via a single wireless carrier. However, when wireless devices are configured to communicate within a network via a single wireless carrier, the wireless devices may fail to maintain service with the wireless carrier. For example, the wireless carrier may experience a loss of service, interference from surrounding networks, or other types of network problems that may disrupt wireless service and/or connections with various wireless devices.

Such loss of service, interference, or other types of network problems may result in interrupted communications for some wireless devices. Interrupted communications for some wireless devices may result in failure in operation of the wireless devices, such as wireless devices that may be relied on to transmit signals to emergency services or transmit emergency alerts. Thus, in various cases where wireless communication must possess a very high reliability and/or up-time (e.g., emergency scenarios), loss and/or interruption of service with a wireless carrier can be damaging for wireless devices and can lead to slow and/or negative response times, undelivered messages and/or alters, and other consequences.

### SUMMARY

Embodiments include a communicator device for evaluating signal strengths of wireless carriers. The communicator device can include a processor, a transceiver coupled to the processor, and memory coupled to the processor. The memory may store program instructions. When the processor executes the program instructions, the program instructions may cause the processor to be configured to establish cellular service with each of one or more cellular carriers. The program instructions may cause the processor to receive, via the transceiver, plural signals transmitted via control channels for each cellular carrier. The program instructions may cause the processor to measure the plural signals to determine a signal strength of each of the plural signals. The program instructions may cause the processor to evaluate the signal strength of each of the plural signals by ranking the signal strength of each of the plural signals from a strongest signal to a weakest signal. The program instructions may cause the processor to select a first cellular carrier of the one or more cellular carriers based on ranking the signal strength of each of the plural signals. The first cellular carrier may have transmitted the strongest signal. The program instructions may cause the processor to maintain cellular service with the first cellular carrier.

Embodiments include a communicator device for evaluating signal strengths of wireless carriers. The communicator device can include a processor, a transceiver coupled to the processor, and memory coupled to the processor. The memory may store program instructions. When executed, the program instructions may cause the processor to be configured to receive, with the transceiver, one or more signals transmitted from one or more hubs. Each of the one or more hubs may be associated with a cellular carrier. The program instructions may cause the processor to be configured to measure the one or more signals to determine a signal strength of each of the one or more signals. The program instructions may further cause the processor to be configured to evaluate the signal strength of each of the one or more signals by ranking the signal strength of each of the one or more signals from a strongest signal to a weakest signal. The program instructions may further cause the processor to be configured to select a hub of the one or more hubs based on ranking the one or more signal strengths, wherein the hub transmitted the strongest signal and is associated with a first cellular carrier. The program instructions may further cause the processor to be configured to establish a connection with the first cellular carrier associated with the hub.

Embodiments include a computer-implemented method for selecting a cellular carrier from a set of cellular carriers. The method can include establishing cellular service with each of plural cellular carriers. The method can include receiving, with a transceiver, plural signals. Each signal of the plural signals may be transmitted via a cellular carrier of the plural cellular carriers. The method can include measuring each signal of the plural signals to provide plural signal strength measurements. The method can include evaluating each of the plural signal strength measurements to determine a first strongest signal strength. The first strongest signal strength may be associated with a first cellular carrier. The method can include maintaining cellular service with the first cellular carrier. The method can include continually monitoring additional signals received via the plural cellular carriers. The method can include switching cellular carriers when a new strongest signal strength is identified that is associated with a second cellular carrier.

Embodiments include a communicator system for evaluating signal strengths of wireless carriers. The communicator system can include a processor, a transceiver coupled to the processor, and memory coupled to the processor. The memory may store program instructions that, when executed, cause the processor to be configured to receive, with the transceiver, one or more signals transmitted from one or more networks. Each of the one or more networks may be associated with a cellular carrier. The program instructions may cause the processor to be configured to measure the one or more signals to determine a signal strength of each of the one or more signals. The program instructions may cause the processor to be configured to evaluate the signal strength of each of the one or more signals by ranking the signal strength of each of the one or more signals from a strongest signal to a weakest signal. The program instructions may cause the processor to be configured to select a network of the one or more networks based on ranking the one or more signal strengths. The selected network may have transmitted the strongest signal and may be associated with a first cellular carrier. The program instructions may cause the processor to be configured to establish a connection with the first cellular carrier associated with the selected network.

Embodiments include a computer-implemented method for signal strength evaluation in wireless communication networks. The method can include receiving, with a transceiver, one or more signals from multiple networks. Each network may be associated with a distinct cellular carrier. The method can include analyzing the received one or more signals to ascertain a respective signal strength of each of the one or more signals to generate one or more signal strength values. The method can include ranking the one or more signal strength values from strongest to weakest. The method can include selecting a network of the multiple networks from the received signals based on ranked signal strengths associated with the selected network. The selected network may be linked to a primary cellular carrier. The method can include establishing a connection with the primary cellular carrier.

Embodiments include a computer-implemented method for selecting a cellular carrier from a set of cellular carriers. The method can include receiving, with a transceiver, one or more signals. The one or more signals may be transmitted by each of one or more hubs. Each of the one or more signals may be associated with at least one cellular carrier of a set of cellular carriers. The method can include measuring each of the one or more signals to provide one or more signal strength measurements. The method can include evaluating, with at least one processor, each of the one or more signal strength measurements to determine a first strongest signal strength. The first strongest signal strength may be associated with a first cellular carrier of the set of cellular carriers. The method can include establishing a connection with the first cellular carrier associated with the first strongest signal strength. The method can include continually monitoring, with the at least one processor, additional signals received from the one or more hubs and switching cellular carriers when a new strongest signal strength is identified that is associated with a second cellular carrier.

Embodiments include a communicator system for evaluating signal strengths of wireless carriers. The communicator system can include a processor, a transceiver coupled to the processor, an antenna coupled to the transceiver, at least one server in communication with the processor, and memory coupled to the processor. The memory may store program instructions that, when executed, cause the processor to be configured to receive, with the antenna and transceiver, one or more signals transmitted from a hub associated with a first carrier. The program instructions may cause the processor to be configured to receive, with the transceiver, service associated with the first carrier. The service may allow information to be transmitted and/or received. The program instructions may cause the processor to be configured to measure the one or more signals to determine a signal strength of service associated with the first carrier. The program instructions may cause the processor to be configured to switch a carrier configuration to receive one or more signals and service associated with additional carriers. The program instructions may cause the processor to be configured to evaluate a respective signal strength and service of each of the additional carriers by ranking each respective signal strength from strongest signal to weakest signal. The program instructions may cause the processor to be configured to select an additional hub associated with at least one additional carrier based on the ranking of each respective signal strength.

Embodiments include a communicator device for evaluating signal strengths of wireless carriers. The communicator device can include a processor, a transceiver coupled to the processor, an antenna coupled to the transceiver, at least one server in communication with the processor, and memory coupled to the processor. The memory may store program instructions that, when executed, will cause the processor to be configured to establish cellular service with a first cellular carrier of plural cellular carriers. The program instructions may cause the processor to be configured to receive, with the transceiver, first plural signals transmitted via a first control channel for the first cellular carrier. The program instructions may cause the processor to be configured to measure the first plural signals to determine first plural signal strengths of each of the first plural signals. The program instructions may cause the processor to be configured to average the first plural signal strengths to determine a first signal strength measurement. The program instructions may cause the processor to be configured to store the first signal strength measurement in the memory. The program instructions may cause the processor to be configured to establish cellular service with a second cellular carrier of the plural cellular carriers. The program instructions may cause the processor to be configured to receive, with the transceiver, second plural signals transmitted via a second control channel for the second cellular carrier. The program instructions may cause the processor to be configured to measure the second plural signals to determine second plural signal strengths of each of the second plural signals. The program instructions may cause the processor to be configured to average the second plural signal strengths to determine a second signal strength measurement. The program instructions may cause the processor to be configured to store the second signal strength measurement in the memory. The program instructions may cause the processor to be configured to establish cellular service with a third cellular carrier of plural cellular carriers. The program instructions may cause the processor to be configured to receive, with the transceiver, third plural signals transmitted via a third control channel for the third cellular carrier. The program instructions may cause the processor to be configured to measure the third plural signals to determine third plural signal strengths of each of the third plural signals. The program instructions may cause the processor to be configured to average the third plural signal strengths to determine a third signal strength measurement. The program instructions may cause the processor to be configured to store the third signal strength measurement in the memory. The program instructions may cause the processor to be configured to evaluate the first, second, and third signal strength measurements by ranking the first, second, and third signal strength measurements from a strongest signal to a weakest signal to generate a ranking structure of signal strength measurements. The program instructions may cause the processor to be configured to store the ranking structure of signal strength measurements in the memory. The program instructions may cause the processor to be configured to select, from the ranking structure of signal strengths, a strongest cellular carrier of the plural cellular carrier, wherein the strongest cellular carrier transmitted the strongest signal and is ranked first in the ranking structure of signal strengths. The program instructions may cause the processor to be configured to reestablish and maintain cellular service with the strongest cellular carrier. The program instructions may cause the processor to be configured to transmit the ranked structure of signal strengths to the server.

### BRIEF DESCRIPTION OF THE DRAWINGS

The disclosure is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. According to common practice, the various features of the drawings are not drawn to scale unless otherwise indicated. To the contrary, the dimensions of the various features may be expanded or reduced for clarity. Embodiments will now be described, strictly by way of example and not limitation, with reference to the accompanying figures, in which:

FIG. 1 is a diagram of an exemplary communicator device and system for evaluating signal strengths of wireless carriers as disclosed herein;

FIG. 2 is a flow diagram of an exemplary method for evaluating signal strengths of wireless carriers as disclosed herein;

FIG. 3 is a diagram of an exemplary system environment for evaluating signal strengths of wireless carriers as disclosed herein; and

FIG. 4 is a diagram of example components of a computing device and/or communicator system as disclosed herein.

### DETAILED DESCRIPTION

In accordance with exemplary embodiments of the present disclosure, devices, systems, and methods may provide an improvement upon cellular communications by determining a cellular carrier having a strongest signal to receive service and establish a connection with such cellular carrier. Embodiments may switch connections with cellular carriers based on continually monitoring signal strengths of signals associated with different cellular carriers of plural cellular carriers in order to remain connected to a cellular carrier having a best (e.g., strongest) signal to improve reliability of systems, such as emergency systems (e.g., E911 systems, fire alert systems, and/or the like). Embodiments may provide a multi-carrier solution with a single device including a subscriber identity module (SIM) card having multiple cellular carrier profiles loaded onto the SIM card. Embodiments may use a computer-implemented method and processor to improve upon usage of cellular carriers such that embodiments can select a cellular carrier having a strongest signal to improve clarity of communication and reduce interference and signal collisions in communication operations. Embodiments may rank cellular carriers based on signal strengths such that embodiments may continually maintain a strongest connection even when some cellular carriers may experience a loss of service. Such maintenance of a connection allows for higher reliability and up-time in communications and communicator devices of disclosed embodiments.

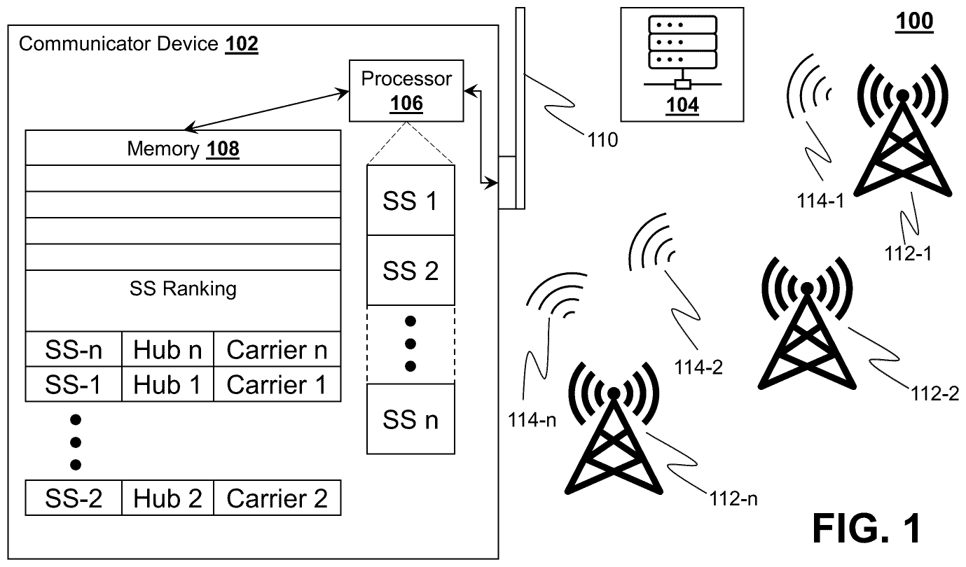

FIG. 1 shows a diagram of an exemplary communicator device 102 and system 100 for evaluating signal strengths of wireless carriers as disclosed herein. Various components shown in FIG. 1 may be implemented in and/or processed by a processor (e.g., a central processing unit (CPU)) and/or on any number of distributed processors (e.g., a distributed computing system) coupled with memory and connected via a communications network. Each of the components shown in FIG. 1 are described in the context of an exemplary embodiment.

As shown in FIG. 1, embodiments may relate to devices and systems configured for evaluating signal strengths of wireless carriers. Exemplary system 100 can include communicator device 102 including processor 106, memory 108, and transceiver 110. Exemplary environment and system 100 may also include one or more hubs 112-1 to 112-n (referred to individually as hub 112 and collectively as plural hubs 112 as appropriate). In some embodiments, exemplary environment and system 100 can include computing device 104 remote from communicator device 102 such that communicator device 102 may communicate with computing device 104 via a wired or wireless connection. Computing device 104 can include at least one server including additional processors to perform similar and/or different functions as processor 106. In some embodiments, computing device 104 can include processor 106 and memory 108 and may be communicably coupled to one or more storage devices.

Communicator device 102 can include processor 106 and memory 108 coupled to processor 106. Communicator device 102 can include transceiver 110 to transmit and receive signals (e.g., signals 114) to and/or from plural hubs 112 using cellular service provided by one or more cellular carriers via hubs 112. In some embodiments, communicator device 102 can include memory 108 coupled to processor 106 where memory 108 stores program instructions local to communicator device 102 which processor 106 can load and execute to perform embodiments described herein. In some embodiments, program instructions may be stored remotely on computing device 104 or another storage device. In some embodiments, processor 106 of communicator device 102 may be configured to execute the program code on startup of communicator device 102. In some embodiments, communicator device (e.g., processor 106 thereof) may be configured to execute the program code to cause processor 106 perform various steps described herein based on communicator device 102 receiving a remote signal via a device message transmitted from a remote server (e.g., computing device 104).

In some embodiments, communicator device 102 can include at least one SIM card. The at least one SIM card can include plural carrier profiles that may be used to establish cellular service with each of one or more cellular carriers. In some embodiments, communicator device 102 may establish cellular service with each of the one or more cellular carriers via signals transmitted over control channels from hubs 112. Each hub 112 may be associated with a separate cellular carrier. For example, hub 112-1 may be associated with a first cellular carrier, hub 112-2 may be associated with a second cellular carrier, etc. up to hub 112-n. In some embodiments, the separate cellular carriers may be provided at least by AT&T®, Verizon®, and/or T-Mobile®.

In some embodiments, computing device 104 can include one or more processors configured to execute program instructions. For example, computing device 104 can include a desktop computer, a portable computer (e.g., laptop computer, tablet computer), a workstation, a mobile device (e.g., smartphone, cellular phone, personal digital assistant, wearable device), a server, and/or other like devices. Computing device 104 can include a computing device configured to communicate with communicator device 102 over a network. Computing device 104 can include a group of computing devices (e.g., a group of servers) and/or other like devices. In some embodiments, computing device 104 can include a data storage device. Alternatively, a data storage device may be separate from computing device 104 and may be in communication with computing device 104 and/or communicator device 102.

Processor 106 may be implemented in hardware, software, or a combination of hardware and software. For example, processor 106 can include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 may be coupled to memory 108 via a data bus to transfer data between processor 106 and memory 108. Processor 106 may be configured to execute program instructions stored in memory 108. Processor 106 may execute program instructions (e.g., compiled program code) for communicator device 102, including program instructions for evaluating signal strengths of signals transmitted by wireless carriers using devices for wireless networks (e.g., hubs 112).

Memory 108 can include random access memory (RAM), read-only memory (ROM), and/or another type of dynamic or static storage device (e.g., flash memory, magnetic memory, optical memory, etc.) that stores information and/or software instructions for use by processor 106. Memory 108 can include a computer-readable medium and/or storage component. A computer-readable medium (e.g., a non-transitory computer-readable medium) is defined herein as a non-transitory memory device. A non-transitory memory device can include memory space located inside of a single physical storage device or memory space spread across multiple physical storage devices.

Program instructions (e.g., software instructions, compiled program code, etc.) may be read into memory 108 from another computer-readable medium or from another device (e.g., computing device 104) via a communication interface with communicator device 102. Program instructions stored in memory 108 may be loaded and executed by processor 106 to cause processor 106 to perform one or more processes described herein. Embodiments described herein are not limited to any specific combination of hardware circuitry and software.

Transceiver 110 can include at least one radio and at least one radio receiver configured for transmitting and/or receiving radio signals in a wireless network environment (e.g., a cellular network environment). Transceiver 110 can include at least one antenna for transmitting and/or receiving analog signals and/or digital signals.

Exemplary system 100 can include one or more hubs 112, such as hub 112-1, hub 112-2, and/or hub 112-n. Communicator device 102 may transmit signals to and/or receive signals from hubs 112. It should be appreciated that the number of hubs 112 that communicator device 102 may communicate with is not limited to any specific number, and in some instances may be determined based on a number of hubs 112 within a communication range of communicator device 102.

In some embodiments, each hub 112 may be associated with a single cellular carrier. Alternatively, each hub 112 may be associated with multiple cellular carriers. In some embodiments, hubs 112 may each be associated with an exclusive cellular carrier such that other hubs 112 are not associated with the exclusive cellular carrier (e.g., separate and distinct cellular carriers). Hubs 112 may be associated with a cellular carrier such that the cellular carrier provides wireless service for cellular connectivity using hubs 112 as a communication device (e.g., a base station) in a wireless network (e.g., a cellular network). In some embodiments, hubs 112 may transmit signals (shown as signals 114) to communicator device 102 which may be received by communicator device 102 to be measured and/or processed. In some embodiments, hubs 112 may receive signals transmitted by communicator device 102, such as signals to be transmitted from communicator device 102 to computing device 104 or from computing device 104 to communicator device 102.

In some embodiments, hubs 112 may be part of one or more networks. For example, hubs 112 may be part of one or more cellular networks, where each hub 112 makes up a cell of a cellular network.

A wireless carrier and/or a cellular carrier may refer to a mobile network operator, a wireless service provider, a cellular company, a mobile network carrier, and/or the like that provides wireless communication services. A wireless carrier and/or cellular carrier may own or control devices, systems, and/or means used to facilitate wireless communication services. Such devices, systems, and/or means for providing wireless communication services can include radio spectrum allocation, wireless network devices and/or infrastructure (e.g., hubs, base stations, cell towers, and/or the like), computing systems, back end systems, and other systems and services associated with providing wireless communication services. Such examples of wireless carriers and/or cellular carriers can include AT&T® and associated equipment and radio spectrum, Verizon® and associated equipment and radio spectrum, and/or T-Mobile® and associated equipment and radio spectrum.

Cellular service may refer to wireless communication service provided by a cellular carrier. For example, a cellular carrier may provide cellular service by allowing a wireless device (e.g., communicator device 102) to convey information over wireless communication frequencies controlled by the cellular carrier. In some embodiments, cellular service may refer to access to a cellular network such that a wireless device provided access to a cellular network is permitted to convey information and/or data over frequency channels provided and/or controlled by a cellular carrier. For example, a device establishing cellular service may be allowed to send and receive wireless signals over frequency channels owned and/or controlled by a cellular carrier and/or equipment (e.g., hubs) transmitting or receiving such wireless signals over the frequency channels owned and/or controlled by the cellular carrier. In some embodiments, a wireless device may establish cellular service with a cellular carrier by receiving control signals via the cellular carrier, registering with the cellular carrier, and being permitted to convey information and/or data over frequency channels provided and/or controlled by the cellular carrier.

As shown in FIG. 1, processor 106 of communicator device 102 may execute program instructions stored in memory 108. When processor 106 executes the program instructions, the program instructions may configure processor 106 such that the program instructions cause processor 106 to perform various functions. In some embodiments, the program instructions may cause processor 106 to establish cellular service with each of one or more cellular carriers. For example, processor 106 may operate in conjunction with transceiver 110 and/or an antenna to establish service with a cellular carrier using a control signal over a control channel. Processor 106 may establish cellular service with each of the one or more cellular carriers at different times (e.g., sequentially, and/or the like) such that communicator device 102 may transmit and/or receive data over a channel of each cellular carrier without interfering with signals from other cellular carriers.

In some embodiments, the program instructions may cause processor 106 to communicate with and/or receive data from transceiver 110. For example, transceiver 110 may receive plural signals transmitted via control channels for each cellular carrier. Transceiver 110 may receive plural signals transmitted over a respective control channel for each cellular carrier, where the plural signals are transmitted from hubs 112. In some embodiments, transceiver 110 may receive plural signals transmitted via control channels from one or more hubs 112. Each of the one or more hubs 112 may be associated with a cellular carrier such that each of the one or more hubs provides wireless service (e.g., cellular service) provided by and/or controlled by the cellular carrier associated with each hub 112. Transceiver 110 may receive the plural signals (e.g., as electromagnetic waves, radio waves, etc.) and may convert the signals to electrical signals for processing by processor 106.

In some embodiments, when executing the program instructions that cause processor 106 to establish cellular service with each of one or more cellular carriers and receive plural signals transmitted via control channels for each cellular carrier, communicator device 102 (e.g., processor 106 and/or transceiver 110 thereof) may establish cellular service with each cellular carrier. Communicator device 102 may then subsequently receive the plural signals for each cellular carrier. Steps of establishing cellular service and receiving the plural signals may be performed by communicator device 102 in a fixed sequential order for each cellular carrier, such that communicator device receives signals from each cellular carrier in a specific order. For example, communicator device 102 may establish cellular service with a first cellular carrier. Then, communicator device may receive plural signals from the first cellular carrier. Once the signals are received, then the signals can be measured and signal strength measurements can be stored. Then, communicator device 102 may establish cellular service with a second cellular carrier and receive plural signals from the second cellular carrier. Then, communicator device 102 may establish cellular service with a third cellular carrier and receive plural signals from the third cellular carrier. Communicator device 102 may both establish cellular service and receive signals in a fixed sequential order such that an order of communication with cellular carriers is predetermined for communicator device 102. For example, communicator device may first establish service with a first cellular carrier based on communicator device 102 being preconfigured with the first cellular carrier. In some embodiments, communicator device 102 may also perform the steps of measuring the plural signals in a fixed sequential order. In some embodiments, a sequential order may be random. For example, in some scenarios, communicator device 102 may establish cellular service with whatever cellular carrier it receives control signals from that communicator device 102 has a carrier profile for. In this way, a sequential order of cellular carriers may not be predetermined and steps of establishing cellular service with cellular carriers and receiving plural signals may be determined at the time of establishing service based on other factors.

In some embodiments, the program instructions may cause processor 106 and/or transceiver 110 to measure the plural signals (e.g., at an antenna of transceiver 110) to determine a signal strength (e.g., in dBm) of each of the plural signals. In some embodiments, processor 106 may determine a signal strength of each of the plural signals received at transceiver 110 by calculating a bit error rate (BER) of each of the one or more signals. It should be appreciated that a signal strength of a wireless signal can be calculated and/or determined in various ways such that processor 106, transceiver 110, and/or communicator device 102 can measure the plural signals to determine a signal strength of each of the plural signals.

In some embodiments, communicator device 102 (e.g., processor 106 thereof), when executing the program instructions that cause processor 106 to be configured to measure the plural signals to determine a signal strength of each of the plural signals, the program instructions may cause processor 106 to be configured to collect plural measurements of a signal over a period of time. The program instructions may cause processor 106 to be configured to determine a time averaged signal strength as the signal strength of the signal based on the plural measurements.

In some embodiments, the program instructions may cause processor 106 to evaluate the signal strength of each of the plural signals by ranking the signal strength of each of the plural signals from a strongest signal to a weakest signal. For example, processor 106 may evaluate a signal strength of each of a first signal 114-1 received from hub 112-1 via cellular service from a first cellular carrier, a second signal 114-2 received from hub 112-2 via cellular service from a second cellular carrier, up to an n signal 114-n received from hub 112-n via cellular service from an n cellular carrier. Processor 106 may determine that a signal strength of signal 114-n (SS-n) is a largest signal strength value (e.g., a strongest signal), such that SS-n is ranked first in memory 108 (e.g., in a data structure stored in memory 108). Processor 106 may determine that a signal strength of signal 114-1 (SS-1) is less than SS-n, but greater than a signal strength of signal 114-2 (SS-2), such that SS-1 is ranked second in memory 108. Processor 106 may determine that a signal strength of signal 114-2 (SS-2) is less than SS-n and SS-1, such that SS-2 is ranked third in memory 108.

In FIG. 1, where three signals SS-1, SS-2, and SS-n are shown, SS-2 is ranked last. However, there may be more signals that are evaluated by processor 106 based on signal strength or there may be less signals evaluated by processor 106 at any time. SS-1, SS-2, and SS-n are provided in FIG. 1 only for example. In some embodiments, each signal strength that is evaluated may be associated with a hub 112 that transmitted the signal. In some embodiments, each signal strength and/or each hub 112 may be associated with a cellular carrier (e.g., carrier 1, carrier 2, carrier n). As an example, the carrier associated with a signal and/or hub 112 may be provided in a data frame of a signal such that processor 106 may identify a carrier associated with each signal when processor 106 evaluates a signal strength of each signal.

In some embodiments, the program instructions may cause processor 106 to select a cellular carrier of one or more cellular carriers based on ranking the signal strength of each of the plural signals. For example, processor 106 may select a first cellular carrier of one or more cellular carriers based on ranking the signal strength of each of the plural signals, where the selected cellular carrier (e.g., the first cellular carrier) had transmitted the strongest signal (e.g., over a control channel via hub 112). In some embodiments, processor 106, when selecting a first cellular carrier of the one or more cellular carriers based on ranking the one or more signal strengths may be based on a time in service for the cellular carrier. In some embodiments, the first cellular carrier of the one or more cellular carriers that is selected may be selected as a preferred cellular carrier by processor 106. For example, processor 106 may select the preferred cellular carrier when the signal strength of the preferred cellular carrier and a second signal strength of a second cellular carrier are ranked at a same position. In some embodiments, the first cellular carrier of the one or more cellular carriers that is selected may be selected as a preferred cellular carrier by processor 106 based on the signal strength of the first cellular carrier exceeding a threshold signal strength.

In some embodiments, the program instructions may cause processor 106 to select a hub 112 of the one or more hubs 112 based on ranking the one or more signal strengths. The hub 112 that is selected by processor 106 can include the hub 112 that transmitted the strongest signal and is associated with a first cellular carrier. For example, as shown in FIG. 1, processor 106 would select hub 112-n because processor 106 ranked signal 114-n having signal strength SS-n as the strongest signal. In the exemplary embodiment shown in FIG. 1, hub 112-n is associated with cellular carrier n, such that cellular carrier n provides wireless services using hub 112-n. Thus, in selecting hub 112-n, processor 106 may cause transceiver 110 to establish a connection with hub 112-n.

In some embodiments, the program instructions may cause processor 106 to maintain cellular service with a cellular carrier that transmitted a strongest signal. For example, processor 106 may maintain cellular service with the first cellular carrier. In this example, processor 106 may forgo switching to a second cellular carrier to receive signals, where processor 106 determined the first cellular carrier had transmitted the strongest signal when ranking signal strengths of signals from multiple cellular carriers and/or hubs 112.

In some embodiments, the program instructions may cause processor 106 to establish a connection with the first cellular carrier associated with a hub. For example, where carrier n is selected as a first cellular carrier, processor 106 may cause transceiver 110 to transmit signals to hub 112-n such that communicator device 102 may establish a connection with carrier n via hub 112-n.

Upon establishing a connection with carrier n for communication, processor 106 may retain storage of the ranking of signal strengths in memory 108. In this way, processor 106 may access the ranking of signal strengths upon a loss of connection and/or service with carrier n. In the exemplary embodiment shown in FIG. 1, if communicator device 102 were to lose service with carrier n, processor 106 could access the ranking stored in memory 18 to identify a next strongest signal strength (e.g., SS-1). Upon identifying SS-1 as a next strongest signal strength, processor 106 could then cause transceiver 110 to establish a connection with carrier 1 such that a reliable and efficient connection could be maintained and remain uninterrupted as long as possible.

In this way, a connection may be established with a cellular carrier providing the strongest signal to communicator device 102 such that data can be transmitted via the cellular carrier providing the strongest signal while the cellular carrier is providing service to communicator device 102, thereby providing a more efficient and reliable communication connection. If communicator device 102 were to lose and/or drop cellular service with the cellular carrier, communicator device may reevaluate signals strengths of signals received from other cellular carriers such that communicator device 102 may maintain cellular service even where some cellular carriers experience a loss of service. Thus, communicator device 102 may maintain the best service and/or connection available for transmitting data and may avoid loss of service scenarios.

In some embodiments, communicator device (e.g., processor 106 and/or transceiver 110 thereof) may be configured to perform steps of establishing service, receiving signals, and measuring a signal of each of the one or more cellular carriers sequentially for each cellular carrier.

In some embodiments, the program instructions may further cause communicator device 102 (e.g., processor 106 thereof) to continually measure additional signals received for each cellular carrier. The program instructions may further cause communicator device 102 (e.g., processor 106 thereof) to select a second cellular carrier of the one or more cellular carriers based on evaluating the signal strength of each of the additional signals. The second cellular carrier may have transmitted an additional signal having a strongest signal strength of the additional signals. In some embodiments, the program instructions may further cause communicator device 102 (e.g., processor 102 thereof) to select a second cellular carrier of the one or more cellular carriers based on ranking the signal strength of each of the plural signals. The second cellular carrier may be selected based on a loss of service associated with and/or occurring with the first cellular carrier.

In some instances, the processor can select a second cellular carrier of the one or more cellular carriers based on ranking the signal strength of each of the plural signals, wherein the second cellular carrier is selected based on degraded performance associated with the first cellular carrier. For example, processor 106 can select a second cellular carrier of the one or more cellular carriers having a next highest signal strength when the first cellular carrier (e.g., previously selected and connected to with processor 106) experiences degraded performance. In some instances, processor 106 can measure and/or detect the degraded performance in the first cellular carrier.

For example, processor 106 can detect the first cellular carrier experiencing consistent performance failure. Processor 106 can cause communicator device 102 to determine and/or perform a carrier switch. In some instances, when a first cellular carrier experiences intermittent performance failure, a central server and/or computing center (e.g., computing device 104) can detect the performance failure and/or determine that communicator device 104 should perform a carrier switch to a second cellular carrier. For example, computing device 104 can detect that the first cellular carrier is experiencing intermittent performance failure and computing device 104 can transmit a signal to communicator device 104 to cause communicator device to switch to establish communication with a second cellular carrier having the next highest signal strength in a list, data object, and/or data structure of ranked cellular carriers ranked based on signal strengths.

Processor 106 and/or computing device 104 can determine a consistent performance failure of a cellular carrier by monitoring and/or checking a cellular internet protocol (IP) connection result. Processor 106 and/or computing device 104 can count a number of cellular IP connection result failures to determine whether to execute a carrier switch, and the number of cellular IP connection result failures can be used to determine a consistent performance failure of a cellular carrier.

In some instances, if processor 106 and/or computing device 104 detect at least one success of the cellular IP connection result, then processor 106 and/or computing device 104 may reset the count of the number of cellular IP connection result failures. Processor 106 and/or computing device 104 can determine to execute the carrier switch (e.g., switching to a second cellular carrier) after a predetermined number (N) of cellular IP connection result failures. Processor 106 and/or computing device 104 can execute the carrier switch (e.g., based on detecting a predetermined number of cellular IP connection result failures) after an amount of time (T) of detecting and/or having no message activity for communicator device 102. An example of a predetermined number of cellular IP connection result failures can include N=3 IP connection result failures, and an example of an amount of time after detecting and/or having no message activity can include T=5 minutes. It should be understood that other values are possible and are contemplated for N and T.

In some embodiments, processor 106 and/or computing device 104 can detect intermittent performance of a cellular carrier (e.g., a first cellular carrier having an established connection with communication device 104). Processor 106 and/or computing device 104 can determine (e.g., separately) to execute a carrier switch where at least one of processor 106 and/or computing device 104 determine a connection to a cellular carrier is not ideal, but is not severe enough to cause communicator device 102 to execute a carrier switch. In such an instance, one of processor 106 and/or computing device can cause communicator device 102 to execute a carrier switch while the other of processor 106 and computing device 104 has not determined that communicator device 102 should execute a carrier switch. For example, processor 106 may only detect a small number of cellular IP connection result failures over time, but not enough cellular IP connection result failures to reach the set number N to cause processor 106 to trigger communicator device 102 to execute a carrier to switch to a second cellular carrier. However, computing device 104 can detect the small number of cellular IP connection result failures over time (e.g., intermittent performance failures) and based on the small number of cellular IP connection result failures, computing device can determine that communicator device 102 should execute a carrier switch. Computing device 104 can then transmit a signal and/or a message to communicator device 102 to cause communicator device 102 to execute a carrier to switch to a second cellular carrier (e.g., a cellular carrier having the next best signal strength). In a non-ideal, intermittent failure condition, connections and/or session failures can be detected over time by processor 106 and/or computing device 104, where processor 106 or computing device 104 can determine the non-ideal carrier and switched to a second cellular carrier, even where a count of a number of cellular IP connection result failures has not reached the predetermined number N, but has reached some amount of failures over time (e.g., intermittent failures).

In some embodiments, processor 106 can be configured to detect a number of cellular IP connection result failures N while computing device 104 is configured to detect intermittent failures. In some embodiments, processor 106 and/or computing device 104 can have these roles swapped such that processor 106 is configured to detect intermittent failures and computing device 104 is configured to detect N connection result failures. In some embodiments, both processor 106 and computing device 104 can be configured to detect both N failures and intermittent failures to cause communicator device 102 to execute a carrier switch.

The number and arrangement of systems, hardware, and/or modules (e.g., software instructions) shown in FIG. 1 is provided as an example. There may be additional systems, hardware, and/or modules, fewer systems, hardware, and/or modules, different systems, hardware, and/or modules, or differently arranged systems, hardware, and/or modules than those shown in FIG. 1. Furthermore, two or more systems, hardware, and/or modules shown in FIG. 1 may be implemented within a single system, hardware, and/or module. A single system, hardware, and/or module shown in FIG. 1 may be implemented as multiple, distributed systems, hardware, and/or modules. Additionally or alternatively, a set of systems, a set of hardware, and/or a set of modules (e.g., one or more systems, one or more hardware devices, one or more modules) of FIG. 1 may perform one or more functions described as being performed by another set of systems, another set of hardware, or another set of modules of FIG. 1.

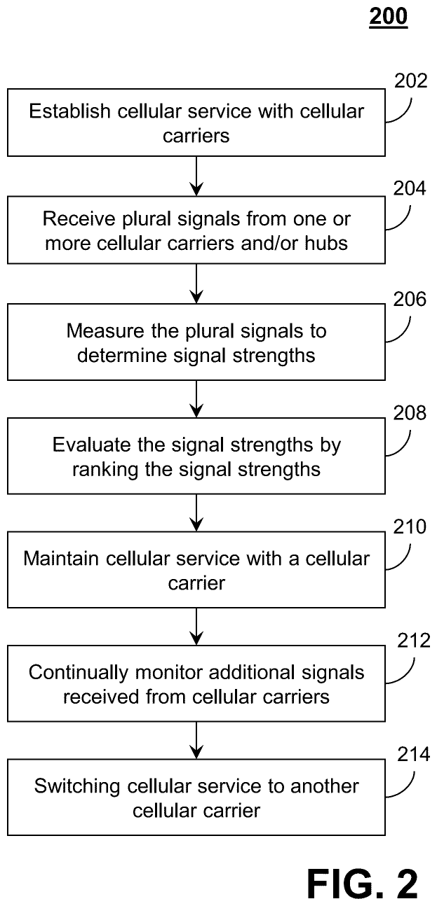

FIG. 2 shows a flow diagram of an exemplary method 200 for evaluating signal strengths of wireless carriers as disclosed herein. In some embodiments, one or more of the functions described with respect to method 200 may be performed (e.g., completely, partially, etc.) by communicator device 102 (e.g., via processor 106). In some embodiments, one or more of the steps of method 200 may be performed (e.g., completely, partially, etc.) by another system, hardware, or module or a group of systems, hardware, or modules separate from or including communicator device 102, such as a client device and/or a separate computing device (e.g., computing device 104).

As shown in FIG. 2, at step 202, method 200 can include establishing cellular service with cellular carriers. For example, communicator device 102 (e.g., processor 106 and/or transceiver 110 thereof) may establish cellular service with each of plural cellular carriers. Establishing service with a cellular carrier can include receiving control signals over a control channel associated with the cellular carrier and registering with the cellular carrier via a SIM card storing a profile for the cellular carrier. For example, cellular service may be established with each of the plural cellular carriers via signals transmitted over control channels from one or more hubs each associated with a separate cellular carrier (e.g., a separate and/or distinct cellular carrier). The separate cellular carriers can include at least AT&T®, Verizon®, and T-Mobile®. In some embodiments, establishing cellular service with each of the plural cellular carriers can include using at least one SIM card that is configured to establish cellular service with each of the cellular carriers of the plural cellular carriers.

At step 204, method 200 can include receiving plural signals from one or more hubs and/or cellular carriers. For example, communicator device 102 (e.g., transceiver 110 thereof) may receive plural signals (e.g., signals 114). The plural signals may be transmitted via a cellular carrier of each of plural cellular carrier. In some embodiments, the plural signals may be transmitted by each of hubs 112 to communicator device 102. Each of the plural signals may be associated with at least one cellular carrier of the plural cellular carriers.

In some embodiments, communicator device 102 may receive, with the transceiver, one or more signals transmitted from one or more networks. Each of the one or more networks may be associated with a cellular carrier (e.g., linked to a primary cellular carrier).

At step 206, method 200 can include measuring the plural signals to determine signal strengths. For example, communicator device 102 (e.g., processor 106 and/or transceiver 110 thereof) may measure each signal of the plural signals to provide plural signal strength measurements. In some embodiments, transceiver 110 may measure power present in the plural signals by determining a received signal strength indicator (RSSI) (e.g., in dBm) of each of the one or more signals received. In some embodiments, processor 106 may measure the one or more signals to provide one or more signal strengths by determining a BER of each of the one or more signals after the one or more signals are received by transceiver 110 and transmitted to processor 106 as digital signals.

In some embodiments, measuring each of the plural signals can include analyzing received signals to ascertain a respective signal strength of each of the one or more signals to generate one or more signal strength values.

In some embodiments, measuring each of the plural signals can include collecting plural measurements for each of the plural signals over a period of time (e.g., collecting a measurements every 5 seconds for 1 minute). Then, processor 106 may determine a time averaged signal strength for each of the plural signals as the signal strength measurement based on the plural measurements for each of the plural signals. For example, communicator device 102 may collect 20 measurements for a signal transmitted via a first cellular carrier every 5 seconds over a span of 1 minute. Processor 106 may generate a time averaged value signal strength of the 20 measurements by averaging the 20 measurements. The time averaged value signal strength may then be used by processor 106 in the evaluation step.

At step 208, method 200 can include evaluating the signal strengths by ranking the signal strengths. For example, processor 106 may evaluate each of the plural signal strength measurements to determine a first strongest signal strength out of the plural signal strength measurements. The first strongest signal strength may be associated with a first cellular carrier of the plural cellular carriers. The first strongest signal strength may also be associated with (e.g., by way of the signal having the strongest signal strength being transmitted from) hub 112 of the one or more hubs.

In some embodiments, processor 106 may select a hub and/or cellular carrier that transmitted the strongest signal. For example, upon evaluating each of the plural signal strength measurements and determining a first strongest signal strength, processor 106 may select and/or identify the hub and/or the cellular carrier that is associated with the signal having the first strongest signal strength. In this way, processor 106 may select a hub and/or a cellular carrier when one or more hubs are associated with a single cellular carrier, or processor 106 may select a cellular carrier in a case where a hub may be associated with multiple cellular carriers.

In some embodiments, processor 106 may select and/or identify the hub and/or cellular carrier by storing an identifier of the hub and/or cellular carrier in memory 108. For example, processor 106 may select carrier n by storing an identifier for carrier n (e.g., “carrier-n”, an identifier number, and/or the like) in a memory location in memory 108 such that the identifier can be accessed by processor 106 when needed. In some embodiments, data stored in memory 108 (e.g., signal strength rankings, associated cellular carriers, associated hubs, other data structures, etc.) may be transmitted to computing device 104 for further processing and/or for storage.

In some embodiments, communicator device 102 (e.g., processor 106 thereof) may select a network of one or more networks based on ranking the one or more signal strengths. The selected network may have transmitted the strongest signal and may be associated with a first cellular carrier. In some embodiments, communicator device 102 may establish a connection with the first cellular carrier associated with the selected network.

At step 210, method 200 can include maintaining cellular service with a cellular carrier. For example, processor 106 may maintain cellular service with the first cellular carrier (e.g., the first cellular carrier selected by processor 106). By maintaining service with the first cellular carrier selected, communicator device 102 and therefore processor 106 forgo maintaining service and/or connections with other cellular services and/or cellular carriers available until a later evaluation of signal strengths is performed and a new first cellular carrier having signals with a strongest signal strength are determined.

In some embodiments, communicator device 102 (e.g., processor 106 thereof) may establish a connection with a cellular carrier associated with hub 112. For example, processor 106 may establish a connection with a first cellular carrier associated with the signal having the first strongest signal strength (e.g., the carrier that was selected in step 208). In some embodiments, processor 106 may establish a connection with a first cellular carrier associated with the signal having the first strongest signal strength where the cellular carrier is associated with a first hub (e.g., the hub selected in step 208). In this way, processor 106 may select a hub where one or more hubs are associated with a single cellular carrier. In a case where a hub is associated with multiple cellular carriers, processor 106 may select the cellular carrier that provided the signal transmission for the signal determined to have the strongest signal strength.

At step 212, method 200 can include continually monitoring additional signals received from cellular carriers and/or hubs. For example, communicator device (e.g., processor 106 and/or transceiver 110 thereof) may continually monitor additional signals 114 received via plural cellular carriers. In some embodiments, communicator device 102 may be configured to monitor signals from each cellular carrier of the plural cellular carriers at a set time interval (e.g., every 5 minutes) while communicator device 102 is powered on.

At step 214, method 200 can include switching cellular service to another cellular carrier. For example, communicator device 102 (e.g. processor 106 thereof) may switch cellular carriers when a new strongest signal strength is identified that is associated with a second cellular carrier. In this way, communicator device 102 may select a first cellular carrier based on a strongest signal strength and maintain service with the first cellular carrier. Communicator device 102 may continually and/or periodically monitor signals from cellular carriers by evaluating signal strengths of signals from all available cellular carriers. In a case where a second cellular carrier has a stronger signal than the first cellular carrier with which service was maintained, communicator device 102 may then switch cellular carriers by terminating service with the first cellular carrier and establishing and/or maintaining service with the second cellular carrier with a new strongest signal.

In some embodiments, switching cellular carriers can include establishing cellular service with a second cellular carrier based on identifying a new strongest signal strength of a signal transmitted via the second cellular carrier. The new strongest signal strength transmitted via the second cellular carrier may be greater than the first strongest signal strength for a signal transmitted via the first cellular carrier (e.g., the originally selected cellular carrier). In some embodiments, before establishing cellular service with a second cellular carrier when switching cellular carriers, communicator device 102 may terminate cellular service with the first cellular carrier (e.g., the originally selected cellular carrier).

In some embodiments, method 200 can include losing cellular service from a first cellular carrier that was selected as a cellular carrier having a strongest signal strength. Once cellular service is lost, communicator device 102 and/or processor 106 may determine that a new cellular carrier must be selected so cellular service is maintained. In this way, communicator device 102 (e.g., processor 106 thereof) may cause communicator device 102 to perform steps of method 200 a subsequent time to establish cellular service with a second cellular carrier (e.g., a preferred cellular carrier). The second cellular carrier may be selected as being associated with a second signal having a second strongest signal strength less than that of the strongest signal (e.g., having the strongest signal strength). In some embodiments, communicator device 102 may select a preferred cellular carrier as the second cellular carrier where a signal strength of a signal transmitted via the preferred cellular carrier exceeds a signal strength threshold. For example, there may be a situation where a first cellular carrier has a strongest signal strength, and a second cellular carrier (e.g., the preferred cellular carrier) has a second strongest signal strength that is less than the strongest signal strength. In this situation, processor 106 may select the preferred cellular carrier where the second strongest signal strength exceeds a signal strength threshold. In this way, communicator device 102 may prefer a certain cellular carrier that has a sufficiently strong signal, even where the preferred cellular carrier does not have the strongest signal strength.

In some embodiments, steps of establishing service (202), receiving signals (204), and measuring a signal of each of the plural cellular carriers (206) may occur sequentially for each cellular carrier. For example, steps 202, 204, and 206 may be first performed for a first cellular carrier in sequence. Then, steps 202, 204, and 206 may be performed for a second cellular carrier in sequence, etc. These steps may be performed for any number of available cellular carriers sequentially.

Steps of method 200 may be performed in various orders and sequences and are not limited to being performed in the order shown in FIG. 2. Accordingly, steps of method 200 are not limited to any particular order and may be performed by various devices and/or components, whether implemented on a single device or multiple, distributed devices. Steps of method 200 may also be performed by a single computing device (e.g., a single processor or multiprocessor) or by multiple (e.g., distributed) computing devices.

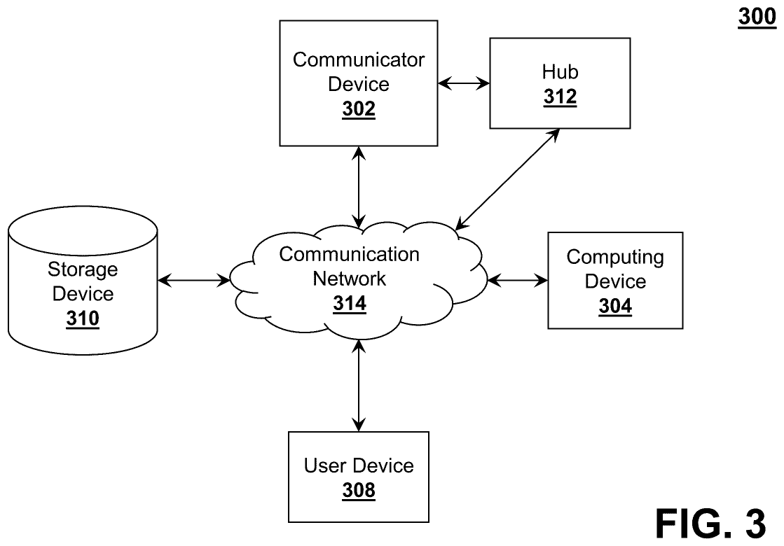

FIG. 3 shows an exemplary system environment 300 for evaluating signal strengths of wireless carriers as disclosed herein. The various components of FIG. 3 may be implemented in one or more computing devices (e.g., one or more servers, client devices, user devices, and/or the like) and the one or more computing devices may be connected via a communications network (e.g., the Internet) to communicator device 302 and/or hub 312. Each of the components shown in FIG. 3 are described in the context of an exemplary embodiment.

As shown in FIG. 3, embodiments relate to a system environment 300 configured for evaluating signal strengths of wireless carriers in which devices, systems, methods, and/or products described herein may be implemented. System environment 300 can include communicator device 302, computing device 304, user device 308, storage device 310, hub 312, and communication network 314. communicator device 302, computing device 304, user device 308, and data storage device 310 may interconnect (e.g., establish a connection to communicate, and/or the like) via wired connections, wireless connections, or a combination of wired and wireless connections. Communicator device 302 may establish a connection to communicate with hub 312 via wired connections, wireless connections, or a combination of wired and wireless connections.

Communicator device 302 can include a device configured to communicate with computing device 304, user device 308, storage device 310, and/or hub 312 (e.g., via communication network 314). Communicator device 302 may be configured to communicate with hub 312 via wireless radio frequency communication (e.g., in a cellular network). In some embodiments, communicator device 302 may be coupled with devices such as computing device 304, user device 306, and/or storage device 310. For example, communicator device 302 may be coupled with a group of computing devices 304 (e.g., servers) and/or other like devices. In some embodiments, communicator device 302 may be associated with (e.g., operated by) user device 308 and/or may be in communication with user device 308 such that user device 308 is configured to transmit messages to communicator device (e.g., to trigger operations on communicator device 302). Computing device 304, user device 308, and/or storage device 310 may be located remotely from communicator device 302. In some embodiments, communicator device 302 may be the same as or similar to communicator device 102.

Computing device 304 can include one or more computing devices, such as processors, storage devices, servers, and/or similar computer components that communicate with communicator device 302, user device 308, storage device 310, hub 312, and/or other computing devices over a network, such as the Internet or private networks and, in some examples, may facilitate communication among other computing devices 304 (e.g., servers) and/or user devices 308. In some embodiments, computing device 304 can include communicator device 302 such that communicator device 302 is integrated with computing device 304. Computing device 304 may transmit a message (e.g., a message and/or a signal causing communicator device 302 to initiate an embodiment of a process described herein) to communicator device 302. Computing device 304 may be the same as or similar to computing device 104.

User device 308 can include one or more computing devices configured to communicate with communicator device 302, computing device 304, and/or storage device 310 via communication network 314. In some embodiments, user device 308 may communicate with hub 312 via a wireless network. As an example, user device 308 can include a desktop computer (e.g., a client device that communicates with a server), a mobile device (e.g., communicating via a cellular network), and/or the like. In some embodiments, user device 308 may be associated with a user (e.g., an individual operating user device 308). User device 308 may transmit a message (e.g., a message and/or a signal causing communicator device 302 to initiate an embodiment of a process described herein) to communicator device 302.

Storage device 310 can include a device storing data that is accessible by communicator device 302, computing device 304, and/or user device 308. For example, storage device 310 may store signal strengths measured by communicator device 302 (e.g., a processor thereof) in a single data field and/or storage device 310 may store signal strengths in a data structure such that the signal strengths are ranked (e.g., a ranked list of signal strengths stored in a data object). In some embodiments, storage device 310 may store identifiers for hubs and/or cellular carriers and storage device 310 may associate the identifiers for hubs and/or cellular carriers with measured signal strengths that are ranked and/or stored in storage device 310. In some embodiments, storage device 310 can include static signal strengths which have been previously measured and stored in storage device 310. Storage device 310 may be updated with new and/or updated measured signal strengths received from one or more hubs and/or one or more cellular carriers. Storage device 310 may be configured to communicate with communicator device 302, computing device 304, and/or user device 308 via communication network 314. In this way, communicator device 302 may transmit (e.g., via a network, such as communication network 314 and/or hubs 312) signal strength measurements to computing device 304 and/or storage device 310 for storage and/or further processing and analysis.

The number and arrangement of systems, hardware, and/or devices shown in FIG. 3 are provided as an example. There may be additional systems, hardware, and/or devices, fewer systems, hardware, and/or devices, different systems, hardware, and/or devices, or differently arranged systems, hardware, and/or devices than those shown in FIG. 3. Furthermore, two or more systems, hardware, and/or devices shown in FIG. 3 may be implemented within a single system, hardware, and/or device. A single system, hardware, and/or device shown in FIG. 3 may be implemented as multiple, distributed systems, hardware, and/or devices. Additionally or alternatively, a set of systems, a set of hardware, and/or a set of devices of FIG. 3 may perform one or more functions described as being performed by another set of systems, another set of hardware, or another set of devices of FIG. 3.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

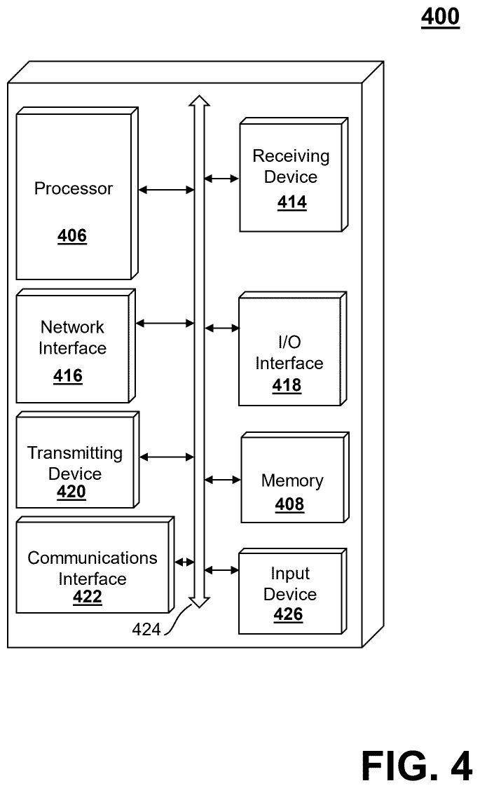

FIG. 4 shows a diagram of example components of a computing system 400 as disclosed herein. Computing system 400 (and/or at least one component of computing system 400) may correspond to at least one of communicator device 102 and/or components of communicator device 102, computing device 104, processor 106, and/or memory 108 in FIG. 1, and/or at least one of communicator device 302, computing device 304, user device 308, storage device 310, and/or communication network 314 in FIG. 3. In some embodiments, such systems or devices in FIGS. 1 and 3 can include at least one computing system 400 and/or at least one component of computing system 400. The number and arrangement of components shown in FIG. 4 are provided as an example. In some embodiments, computing system 400 can include additional components, fewer components, different components, or differently arranged components than those shown in FIG. 4. Additionally, or alternatively, a set of components (e.g., one or more components) of computing system 400 may perform one or more functions described as being performed by another set of components of computing system 400.

Computing system 400 can include processor 406, memory 408, a receiving device 414, network interface 416, input/output (I/O) interface 418, transmitting device 420, communications interface 422, communication infrastructure 424, and input device 426. Processor 406 may be the same as or similar to processor 106 as disclosed herein. Memory 408 may be the same as or similar to memory 108 as disclosed herein. Receiving device 414 and/or transmitting device 420 may be the same as or similar to transceiver 110 as disclosed herein. Communications infrastructure 424 may be the same as or similar to communication network 314.

Memory 408 can be configured for storing program code for configuring processor 406 to cause processor 406 to perform steps of methods disclosed herein. Memory 408 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with computing system 400 via a mobile communication network. According to an exemplary embodiment, an external memory device can be used in place of any resident memory devices. Data stored in computing system 400 may be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by processor 406, and software or program code used by processor 406 for performing tasks associated with exemplary embodiments described herein. The data may be configured in any type of suitable database configuration (e.g., in a storage device), such as a relational database, a structured query language (SQL) database, a distributed database, an object database, etc. Suitable configurations and storage types will be apparent to persons having skill in the relevant art.

Receiving device 414 may be a combination of hardware and software components configured to receive data samples from a mobile network or database. According to exemplary embodiments, receiving device 414 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 414 can be an input device for receiving signals and/or data samples formatted according to 3GPP protocols and/or standards. Receiving device 414 can be connected to other devices via a wired or wireless network or via a wired or wireless direct link or peer-to-peer connection without an intermediate device or access point. The hardware and software components of receiving device 414 can be configured to receive data from a mobile network according to one or more communication protocols and data formats. For example, receiving device 414 can be configured to communicate over a network, which can include a local area network (LAN), a wide area network (WAN), a wireless network (e.g., Wi-Fi, cellular), a mobile communication network, a satellite network, the Internet, fiber optic cable, coaxial cable, infrared, radio frequency (RF), another suitable communication medium as desired, or any combination thereof. During a receive operation, receiving device 414 can be configured to identify parts of the received data via a header and parse the data signal and/or data packet into small frames (e.g., bytes, words) or segments for further processing at processor 406.

Processor 406 can be configured for executing the program code stored in memory 408. Upon execution, the program code causes processor 406 to perform functions at a node on a mobile communication network or remote computing device (e.g., server, computer, computing device 104, etc.) of a user. Processor 406 can be a special purpose or a general purpose computing device encoded with program code or software for performing exemplary functions and/or features disclosed herein. According to exemplary embodiments, processor 406 can include a CPU. The CPU can be connected to a communications infrastructure including a bus, message queue, or network, multi-core message-passing scheme, for communicating with other components of computing system 400, such as memory 408, input device 426, communications interface 422, and I/O interface 418. The CPU can include one or more processors such as a microprocessor, microcomputer, programmable logic unit or any other suitable hardware computing devices as desired.

I/O interface 418 can be configured to receive a signal from processor 406 and generate an output suitable for a peripheral device via a direct wired or wireless link. I/O interface 418 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 420 can be configured to receive data from processor 406 and assemble the data into a data signal and/or data packets according to the specified communication protocol and data format of a peripheral device or remote device to which the data is to be sent. Transmitting device 420 can include any one or more of hardware and software components for generating and communicating a data signal over communications infrastructure 424 and/or via a direct wired or wireless link to a peripheral or remote device. Transmitting device 420 can be configured to transmit information according to one or more communication protocols and data formats as discussed in connection with receiving device 414.

According to exemplary embodiments, memory 408 and processor 406 can store and/or execute computer program code for performing various functions described herein. It should be understood that the program code can be stored on a non-transitory computer readable medium, such as memory devices for computing system 400, which may be memory semiconductors (e.g., DRAMs, etc.) or other tangible non-transitory means for providing software to computing system 400. The computer programs (e.g., computer control logic) or software may be stored in memory devices (e.g., memory 408) resident on/in computing system 400. The computer programs may also be received from external storage devices and/or network storage locations via a communications interface. Such computer programs, when executed, may enable computing system 400 to implement the present methods and exemplary embodiments discussed herein. Accordingly, such computer programs may represent controllers of computing system 400. Where the present disclosure is implemented using software, the software may be stored in a computer program product or non-transitory computer readable medium and loaded into computing system 400 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower level language suitable for controlling computing system 400 to perform functions disclosed herein. It will be apparent to persons having skill in the relevant art that such processes result in computing system 400 being specially configured and/or uniquely programmed to perform functions of exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A communicator device for evaluating signal strengths of wireless carriers, comprising:
a processor;
a transceiver coupled to the processor; and
memory coupled to the processor, the memory storing program instructions, wherein when executing the program instructions the program instructions will cause the processor to be configured to:
establish cellular service with each of one or more cellular carriers;
receive, with the transceiver, plural signals transmitted via control channels for each cellular carrier;
measure the plural signals to determine a signal strength of each of the plural signals;
evaluate the signal strength of each of the plural signals by ranking the signal strength of each of the plural signals from a strongest signal to a weakest signal;
select a first cellular carrier of the one or more cellular carriers based on ranking the signal strength of each of the plural signals, wherein the first cellular carrier transmitted the strongest signal; and
maintain cellular service with the first cellular carrier.

2. The communicator device of claim 1, wherein the program instructions will further cause the processor to:
continually measure additional signals received for each cellular carrier; and
select a second cellular carrier of the one or more cellular carriers based on evaluating the signal strength of each of the additional signals, wherein the second cellular carrier transmitted an additional signal having a strongest signal strength of the additional signals.

3. The communicator device of claim 1, further comprising at least one subscriber identity module (SIM) card, the at least one SIM card including plural carrier profiles to establish cellular service with each of one or more cellular carriers.

4. The communicator device of claim 1, wherein cellular service is established with each of the one or more cellular carriers via signals transmitted over the control channels from one or more hubs, each hub associated with a separate cellular carrier.

5. The communicator device of claim 4, wherein the separate cellular carriers are provided at least by AT&T®, Verizon®, and T-Mobile®.

6. The communicator device of claim 1, wherein the processor is configured to execute the program instructions on startup of the communicator device.

7. The communicator device of claim 1, wherein the processor is configured to perform steps of establishing service, receiving signals, and measuring a signal of each of the one or more cellular carriers sequentially for each cellular carrier.

8. The communicator device of claim 1, wherein the program instructions will further cause the processor to:
select a second cellular carrier of the one or more cellular carriers based on ranking the signal strength of each of the plural signals, wherein the second cellular carrier is selected based on a loss of service associated with the first cellular carrier.

9. The communicator device of claim 1, wherein the program instructions will cause the processor to:
determine the first cellular carrier is experiencing degraded service based on detecting a number of cellular internet protocol (IP) connection result failures for the cellular service with the first cellular carrier;
select a second cellular carrier of the one or more cellular carriers based on ranking the signal strength of each of the plural signals, wherein the second cellular carrier is selected based on the degraded service of the first cellular carrier.

10. The communicator device of claim 1, wherein the processor is configured to execute the program code based on receiving a remote signal via a device message transmitted from a remote server.

11. The communicator device of claim 1, wherein, when executing the program instructions that cause the processor to be configured to measure the plural signals to determine a signal strength of each of the plural signals, the program instructions will cause the processor to be configured to:
collect plural measurements of a signal over a period of time; and
determine a time averaged signal strength as the signal strength of the signal based on the plural measurements.

12. The communicator device of claim 1, wherein selecting a first cellular carrier of the one or more cellular carriers based on ranking the one or more signal strengths is based on a time in service for the cellular carrier.

13. The communicator device of claim 1, wherein the first cellular carrier of the one or more cellular carriers that is selected is a preferred cellular carrier when the signal strength of the preferred cellular carrier and a second signal strength of a second cellular carrier are ranked at a same position.

14. The communicator device of claim 1, wherein, when executing the program instructions that cause the processor to be configured to establish cellular service with each of one or more cellular carriers and receive plural signals transmitted via control channels for each cellular carrier, the program instructions will cause the processor to be configured to:
establish cellular service with each cellular carrier and subsequently receive the plural signals for each cellular carrier in a fixed sequential order.

15. The communicator device of claim 1, wherein the first cellular carrier of the one or more cellular carriers that is selected is a preferred cellular carrier based on the signal strength of the first cellular carrier exceeding a threshold signal strength.

16. A computer-implemented method for selecting a cellular carrier from a set of cellular carriers, the method comprising:
establishing cellular service with each of plural cellular carriers;
receiving, with a transceiver, plural signals, wherein each signal of the plural signals are transmitted via a cellular carrier of the plural cellular carriers;
measuring each signal of the plural signals to provide plural signal strength measurements;
evaluating, with at least one processor, each of the plural signal strength measurements to determine a first strongest signal strength, wherein the first strongest signal strength is associated with a first cellular carrier;
maintaining cellular service with the first cellular carrier;
continually monitoring, with the at least one processor, additional signals received via the plural cellular carriers; and
switching cellular carriers when a new strongest signal strength is identified that is associated with a second cellular carrier.

17. The computer-implemented method of claim 16, wherein establishing cellular service with each of the plural cellular carriers includes using at least one subscriber identity module (SIM) card that is configured to establish cellular service with each of the cellular carriers of the plural cellular carriers.

18. The computer-implemented method of claim 16, wherein cellular service is established with each of the plural cellular carriers via signals transmitted over control channels from one or more hubs each associated with a separate cellular carrier.

19. The computer-implemented method of claim 16, wherein the separate cellular carriers are provided at least by AT&T®, Verizon®, and T-Mobile®.

20. The computer-implemented method of claim 16, wherein steps of establishing service, receiving signals, and measuring a signal of each of the plural cellular carriers occur sequentially for each cellular carrier.

21. The computer-implemented method of claim 16, wherein switching cellular carriers comprises:
establishing cellular service with the second cellular carrier based on identifying the new strongest signal strength, wherein the new strongest signal strength is greater than the first strongest signal strength; and
terminating service with the first cellular carrier.

22. The computer-implemented method of claim 16, wherein measuring each of the plural signals comprises:
collecting plural measurements for each of the plural signals over a period of time; and
determining a time averaged signal strength for each of the plural signals as the signal strength measurement based on the plural measurements for each of the plural signals.

23. The computer-implemented method of claim 16, comprising:
losing cellular service from the first cellular carrier; and
establishing cellular service with a preferred cellular carrier, wherein the preferred cellular carrier is associated with a second signal having a second signal strength exceeding a signal strength threshold.

24. The computer-implemented method of claim 16, comprising:
determining that the first cellular carrier is experiencing degraded service based on detecting a number of cellular internet protocol (IP) connection result failures for the cellular service with the first cellular carrier;
selecting a second cellular carrier of the one or more cellular carriers based on ranking the signal strength of each of the plural signals, wherein the second cellular carrier is selected based on the degraded service of the first cellular carrier.

25. A communicator system for evaluating signal strengths of wireless carriers, comprising:
a processor;
a transceiver coupled to the processor; and
memory coupled to the processor, the memory storing program instructions, wherein when executing the program instructions, the program instructions will cause the processor to be configured to:
receive, with the transceiver, one or more signals transmitted from one or more networks, wherein each of the one or more networks is associated with a cellular carrier;
measure the one or more signals to determine a signal strength of each of the one or more signals;
evaluate the signal strength of each of the one or more signals by ranking the signal strength of each of the one or more signals from a strongest signal to a weakest signal;
select a network of the one or more networks based on ranking the one or more signal strengths, wherein the selected network transmitted the strongest signal and is associated with a first cellular carrier; and
establish a connection with the first cellular carrier associated with the selected network.

26. A computer-implemented method for signal strength evaluation in wireless communication networks, comprising:
receiving, with a transceiver, one or more signals from multiple networks, each network associated with a distinct cellular carrier;
analyzing the received one or more signals to ascertain a respective signal strength of each of the one or more signals to generate one or more signal strength values;
ranking the one or more signal strength values from strongest to weakest;
selecting a network of the multiple networks from the received signals based on ranked signal strengths associated with the selected network, wherein the selected network is linked to a primary cellular carrier; and
establishing a connection with the primary cellular carrier.

27. A communicator system for evaluating signal strengths of wireless carriers, comprising:
a processor;
a transceiver coupled to the processor;
an antenna coupled to the transceiver;
at least one server in communication with the processor; and
memory coupled to the processor, the memory storing program instructions, wherein when executing the program instructions the program instructions will cause the processor to be configured to:
receive, with the antenna and transceiver, one or more signals transmitted from a hub associated with a first carrier;
receive, with the transceiver, service associated with the first carrier, wherein service allows information to be transmitted and/or received;
measure the one or more signals to determine a signal strength of service associated with the first carrier;
switch a carrier configuration to receive one or more signals and service associated with additional carriers;
evaluate a respective signal strength and service of each of the additional carriers by ranking each respective signal strength from strongest signal to weakest signal; and
select an additional hub associated with at least one additional carrier based on the ranking of each respective signal strength.

28. A communicator device for evaluating signal strengths of wireless carriers, comprising:
a processor;
a transceiver coupled to the processor;
an antenna coupled to the transceiver;
at least one server in communication with the processor; and
memory coupled to the processor, the memory storing program instructions, wherein when executing the program instructions the program instructions will cause the processor to be configured to:
establish cellular service with a first cellular carrier of plural cellular carriers;
receive, with the transceiver, first plural signals transmitted via a first control channel for the first cellular carrier;
measure the first plural signals to determine first plural signal strengths of each of the first plural signals;
average the first plural signal strengths to determine a first signal strength measurement;
store the first signal strength measurement in the memory;
establish cellular service with a second cellular carrier of the plural cellular carriers;
receive, with the transceiver, second plural signals transmitted via a second control channel for the second cellular carrier;
measure the second plural signals to determine second plural signal strengths of each of the second plural signals;
average the second plural signal strengths to determine a second signal strength measurement;
store the second signal strength measurement in the memory;
establish cellular service with a third cellular carrier of plural cellular carriers;
receive, with the transceiver, third plural signals transmitted via a third control channel for the third cellular carrier;
measure the third plural signals to determine third plural signal strengths of each of the third plural signals;
average the third plural signal strengths to determine a third signal strength measurement;
store the third signal strength measurement in the memory;
evaluate the first, second, and third signal strength measurements by ranking the first, second, and third signal strength measurements from a strongest signal to a weakest signal to generate a ranking structure of signal strength measurements;
store the ranking structure of signal strength measurements in the memory;
select, from the ranking structure of signal strengths, a strongest cellular carrier of the plural cellular carrier, wherein the strongest cellular carrier transmitted the strongest signal and is ranked first in the ranking structure of signal strengths;
reestablish and maintain cellular service with the strongest cellular carrier; and
transmit the ranked structure of signal strengths to the server.
